(19) United States
(12) Patent Application Publication
(10) Pub. No.: US 2017/0006050 A1
(43) Pub. Date: Jan. 5, 2017

(54) COMMUNICATION SYSTEM, COMMUNICATION METHOD AND GATEWAY

(71) Applicant: FUJITSU LIMITED, Kawasaki-shi (JP)

(72) Inventors: Takeshi KAWASAKI, Kawasaki (JP); Izuru Sato, Chiyoda (JP); Kenichi Fukuda, Yokohama (JP)

(21) Appl. No.: 15/190,856

(22) Filed: Jun. 23, 2016

(30) Foreign Application Priority Data
Jul. 1, 2015 (JP) 2015-132981

(51) Int. Cl. H04L 29/06; H04W 12/08; H04W 40/22; H04L 12/721; H04L 12/823

(52) U.S. Cl. CPC H04L 63/1416; H04L 45/38; H04L 47/32; H04W 40/22; H04L 63/1425; H04L 63/1441; H04L 63/0245; H04W 12/08

(57) ABSTRACT

A communication system configured to control a packet communication between a terminal device and an information processing device, the communication system includes a memory, and at least one processor coupled to the memory and configured to set a first communication path between the communication system and the terminal device, receive a first packet from the terminal device through the first communication path, a destination of the first packet being the information processing device, detect that the first packet belongs to a first flow and is to be blocked before the first packet reaches the information processing device, set a second communication path for the first flow between the terminal device and the communication system, receive a second packet belonging to the first flow from the terminal device through the second communication path, and block the second packet not to be sent to the information processing device.

### CROSS-REFERENCE TO RELATED APPLICATION

This application is based upon and claims the benefit of priority of the prior Japanese Patent Application No. 2015-132981, filed on Jul. 1, 2015, the entire contents of which are incorporated herein by reference.

### FIELD

The embodiments discussed herein are related to a communication system, a communication method and a gateway.

### BACKGROUND

For business, there is a case where an employee carrying a mobile terminal accesses an office network through a mobile network from outside of the office. The development of the mobile network is expected to increase the number of accesses to the office network. The mobile terminal may also access a public server coupled to a public network such as the Internet through the mobile network. When the public server is installed by a malicious attacker, the mobile terminal is infected with a virus from access to the public server, leading to a possibility of being taken over by the attacker. In this case, the attacker may attack the office network by using the virus-infected mobile terminal.

Against attack by the mobile terminal taken over by the attacker through access to the office network and for protection of data within the office network, a protection device called an intrusion prevention system (IPS) is installed at an entrance to the office network from the mobile network. The protection device monitors behavior of communication between the mobile terminal and the office network. The protection device blocks communication with suspected attack (hereinafter referred to as “attack communication”) by discarding packets of a flow associated with the attack communication.

The protection device keeps on discarding the packets of the flow associated with the communication determined to be the attack communication. Therefore, an increase in flows determined to be the attack communication may increase processing load of the protection device.

As examples of the conventional technique, there have been known Japanese National Publication of International Patent Application No. 2011-512731, Japanese Laid-open Patent Publication No. 2006-217198, and Japanese Laid-open Patent Publication No. 2014-103484.

### SUMMARY

According to an aspect of the invention, a communication system configured to control a packet communication between a terminal device and an information processing device, the communication system includes a memory, and at least one processor coupled to the memory and configured to set a first communication path between the communication system and the terminal device, receive a first packet from the terminal device through the first communication path, a destination of the first packet being the information processing device, detect that the first packet belongs to a first flow and is to be blocked before the first packet reaches the information processing device, set a second communication path for the first flow between the terminal device and the communication system, receive a second packet belonging to the first flow from the terminal device through the second communication path, and block the second packet not to be sent to the information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example of a communication system (network system) according to an embodiment.

FIG. 2 illustrates a hardware configuration example of an information processor (computer) usable as an IPS, an S-GW, a P-GW, and an MME.

FIG. 3 illustrates a hardware configuration example of a base station.

FIG. 4 illustrates a hardware configuration example of a terminal.

FIG. 5 is a sequence diagram illustrating a specific processing example of Operation Example 1.

FIG. 6 is a sequence diagram illustrating an operation example (Operation Example 2) when a blocking bearer is already set and the IPS detects another attack communication flow.

FIG. 7 is a flowchart illustrating a processing example in the P-GW.

FIG. 8 is a flowchart illustrating a processing example in a blocking bearer setting phase in the S-GW.

FIG. 9 is a flowchart illustrating a processing example in a packet transfer phase in the S-GW.

FIG. 10 schematically illustrates packet transfer from the terminal (UE) to the P-GW.

FIG. 11 illustrates a modified example of Embodiment 1.

FIG. 12 is a sequence diagram illustrating an operation example of Embodiment 2.

FIG. 13 illustrates procedures of resetting a Default Bearer of the terminal after releasing Default Bearer.

FIG. 14 is a flowchart illustrating a processing example of the P-GW in Embodiment 2.

FIG. 15 is a flowchart illustrating a processing example of the P-GW after completion of the processing in 35 of FIG. 14.

### DESCRIPTION OF EMBODIMENT(S)

In consideration of the above problem, a method is conceivable in which a device within the mobile network is notified of information on a flow determined to be attack communication, and the device specifies the flow of the attack communication and discards packets of the flow. However, in the radio communication standard specified by 3rd Generation Partnership Project (3GPP) such as Long Term Evolution (LTE), a communication path called a bearer is set between the mobile terminal and a gateway to be an exit of the mobile network. The packets from the mobile terminal are transferred on the bearer. More specifically, a relay device for the packets within the mobile network relays the packets by using an identifier of the bearer, and does not identify flow information stored in the packets in this event. Thus, even if the relay device in the mobile network receives flow information on attack communication, it is difficult to determine and discard a target packet.

The embodiments are made in consideration of the above problem. It is an object of the embodiments to provide a technology capable of avoiding transfer of packets of an attack communication flow to a destination network.

Hereinafter, with reference to the drawings, embodiments are described. The configurations of the embodiments are illustrative only and not intended to be restrictive.

### Embodiment 1

A mobile communication system according to an embodiment includes a gateway configured to transfer packets from a mobile terminal to a destination network of the packets, the packets being received through a communication path in a mobile network set between the gateway and the mobile terminal coupled to the mobile network. The gateway issues a request to set a blocking communication path, which is different from the communication path, for blocking an attack communication flow by using specification information for the attack communication flow received from a protection device for the destination network when a flow of the packets is the attack communication flow. The mobile communication system further includes a block unit configured to perform processing of blocking the attack communication flow transferred through the blocking communication path set between the mobile terminal and the gateway in response to the setup request.

The mobile network according to the embodiment includes: a function to set a communication path for blocking the attack communication flow detected by the protection device in the mobile network; and a block function (block unit) to perform processing of blocking the attack communication flow transferred on the blocking communication path. The block unit may be provided in a device configured to transmit or relay packets transferred through the blocking communication path in the mobile network, for example. The device in which the block unit is provided may be selected from among a serving gateway (S-GW), a packet data network gateway (P-GW), a base station, and a mobile terminal, for example. The processing of blocking the attack communication flow includes at least one of processing of discarding packets of the attack communication flow and processing of transferring the packets of the attack communication flow to a device different from the gateway, for example.

When a packet flow is determined to be an attack communication flow (the attack communication flow is detected), the protection device notifies the gateway disposed between the mobile network and the destination network of information (also called flow specification information, “blocking flow information”) for specifying the attack communication flow. When no blocking communication path is set between the gateway and the mobile terminal, the gateway in the mobile network sets the blocking communication path corresponding to the blocking flow information between the mobile terminal and the gateway by following procedures to set the communication path. More specifically, the blocking communication path, through which packets of the attack communication flow are transferred, is set (established) between the mobile terminal and the gateway. The mobile terminal performs setting for sending the packets of the attack communication flow to the blocking communication path. Thus, packets of a flow to be blocked are sent to the blocking communication path from the mobile terminal. The device including the block unit performs block processing on the packets to be transferred through the blocking communication path. More specifically, the block unit discards the packets or transfers the packets to a device different from the gateway. The device different from the gateway may discard, capture or log the packets transferred by the block unit. In either case, the packets are no longer transferred to the destination network through the gateway. Thus, transfer of the packets of the attack communication flow to the destination network is avoided. Therefore, load on the protection device is reduced. Note that, when the block unit is provided in the mobile terminal, the “mobile network” includes the mobile terminal and a radio section from the mobile terminal to the base station.

<Configuration Example of Network System>

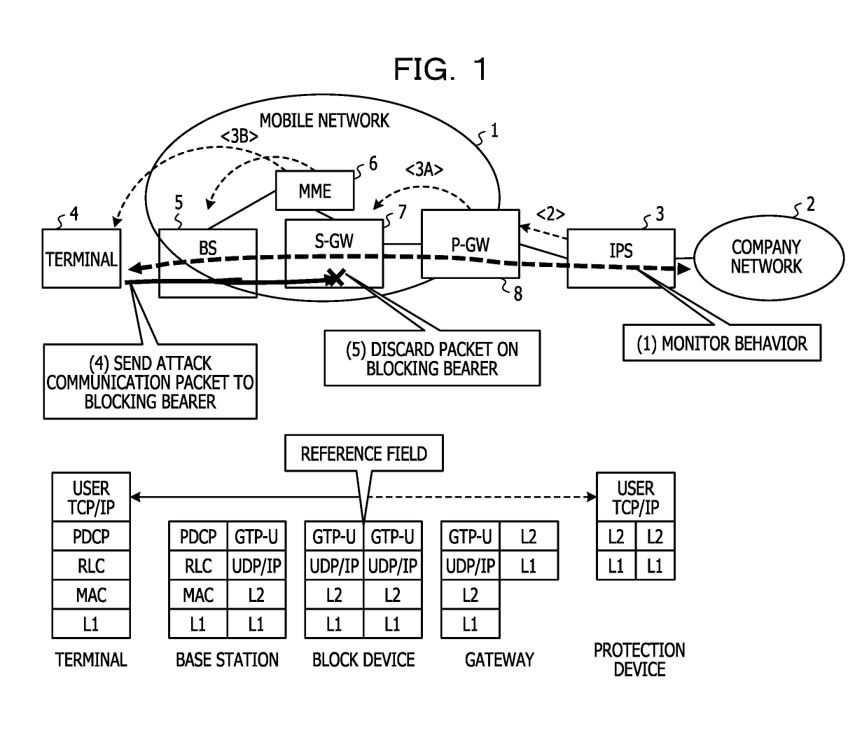

FIG. 1 illustrates a configuration example of a network system according to the embodiment. The network system includes: a mobile network 1 to which a mobile terminal 4 (hereinafter referred to as the “terminal 4”) is coupled; and a company network 2 coupled to the mobile network 1. A protection device (IPS) 3 is installed between the mobile network 1 and the company network 2. The company network 2 is an example of the “destination network”.

In the example illustrated in FIG. 1, the mobile network 1 is an LTE network. However, the mobile network 1 may be a network based on radio communication standards other than the LTE. The radio communication standards other than the LTE include, for example, wideband code division multiple access (W-CDMA) (also called Universal Mobile Telecommunications System (UMTS)), CDMA 2000, Global System for Mobile Communications (GSM), and the like.

In the example illustrated in FIG. 1, the mobile network 1 includes a base station (also described as BS, “eNB”) 5 which accommodates the terminal 4, a Mobility Management Entity (MME) 6, a serving gateway (S-GW) 7, and a packet data network gateway (P-GW) 8. The base station 5 and the S-GW 7 are an example of a “packet relay device”.

The base station 5 is wirelessly coupled to the terminal (called user equipment (UE)) 4 that is the mobile terminal (radio terminal). The terminal 4 is coupled to (accommodated in) the mobile network 1 by wireless coupling. The MME 6 is a controller of the mobile network 1. The S-GW 7 relays packets (called user packets) on a user plane, which are transmitted and received through the mobile network 1 by the terminal 3. The P-GW 8 is a gateway between the mobile network 1 and an external network. The company network 2 is one of the external networks.

The terminal 4 accesses the company network 2 through the mobile network 1. When the terminal 4 is wirelessly coupled to the base station 5, location registration of the terminal 4 is performed in the mobile network 1. Then, under the control of the MME 6, a communication path (bearer) for transferring packets is set between the terminal 4 and the P-GW 8. More specifically, the MME 6 requests the S-GW 7 to set the bearer. Upon receipt of the request to set the bearer, the S-GW 7 sets a bearer between the S-GW 7 and the P-GW 8 and sets a bearer between the S-GW 7 and the base station 5. A radio bearer, which constitutes a part of the communication path, is set between the base station 5 and the terminal 4. Thus, the communication path (bearer) from the terminal 4 to the P-GW 8 includes the bearer between the S-GW 7 and the P-GW 8, the bearer between the S-GW 7 and the base station 5, and the radio bearer between the base station 5 and the terminal 4.

The bearer between the base station 5 and the S-GW 7 and the bearer between the S-GW 7 and the P-GW 8 are GTP tunnels generated based on a General Packet Radio System (GPRS) tunneling protocol (GTP) used in a GTP-U layer, for example. The GTP tunnel is also called a GTP path, and is identified by an identifier of the tunnel (path) called a tunnel endpoint identifier (TEID). The TEID is treated as a bearer identifier corresponding to a packet transferred through the bearer.

A packet transferred on the bearer is provided with a header (GTP header) including a TEID corresponding to the packet (the packet is encapsulated by the GTP header). The packet is transferred within the mobile network 1 according to the TEID and relayed by the S-GW 7 to reach the P-GW 8. The P-GW 8 removes the GTP header (decapsulation) and transfers the packet according to a header (for example, a transmission control protocol/internet protocol (TCP/IP) header) of the packet. For example, when a destination IP address of the packet indicates a host within the company network 2, the packet is transferred to the company network 2.

The IPS 3 receives the packet to the company network 2, and determines whether or not a flow of the packet is an attack communication flow. For example, when a reception status of the packet coincides with a predetermined attack pattern, the IPS 3 determines that the packet flow is the attack communication flow. However, a method for determining or detecting the attack communication flow may be appropriately selected from among various existing methods.

The packet flow is specified by a source port number, a destination port number, a source IP address, and a destination IP address in the TCP/IP header given to the packet, for example. In Embodiment 1, a combination of the source port number, the destination port number, the source IP address, and the destination IP address is handled as flow specification information. However, the flow specification information is not limited to the combination of the port numbers and the IP addresses described above. For example, any of the source and destination port numbers, the source IP address, and the destination IP address may be set arbitrary, and the rest thereof may be handled as the flow specification information. Alternatively, any one of the source and destination port numbers, the source IP address, and the destination IP address may be replaced by another parameter. Alternatively, information obtained by adding other parameters to the combination of the source and destination port numbers and the source and destination IP addresses may be handled as the flow specification information.

The block function (block point) in the mobile network 1 for the attack flow is provided in the S-GW 7 in the example illustrated in FIG. 1. However, the block function may be provided in the P-GW 8 or the base station 5. The block function may also be provided in the terminal 4. In the example of FIG. 1, the S-GW 7 provided with the block function discards a packet transferred through a blocking bearer set in the mobile network 1 upon receipt of a notice from the IPS 3 to the P-GW 8. The blocking bearer is an example of a “blocking communication path”.

<Hardware Configuration of IPS, S-GW, P-GW, and MME>

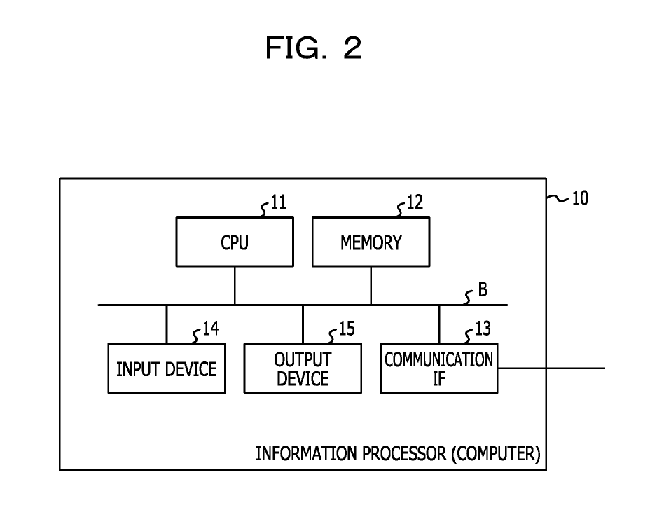

Next, description is given of a hardware configuration of the IPS 3, the S-GW 7, the P-GW 8, and the MME 6. FIG. 2 is a diagram illustrating a hardware configuration of an information processor (computer) usable as the IPS 3, the S-GW 7, the P-GW 8, and the MME 6.

In FIG. 2, an information processor 10 includes a central processing unit (CPU) 11, a memory 12, a communication interface (communication IF) 13, an input device 14, and an output device 15, which are coupled to each other through a bus B. A dedicated or general-purpose computer may be used as the information processor 10. For example, a personal computer (PC), a work station (WS) or a server machine may be used as the information processor 10. However, a computer used as the information processor 10 is not limited to the kinds of computer described above.

The memory 12 includes a non-volatile storage medium and a volatile storage medium. Examples of the non-volatile storage medium include a read only memory (ROM), a hard disk drive (HDD), a solid state drive (SSD), a flash memory, an electrically erasable programmable read-only memory (EEPROM), and the like. The non-volatile storage medium may include a portable storage medium such as a disk storage medium or a Universal Serial Bus (USB) memory. The non-volatile storage medium stores programs to be executed by the CPU 11 and data to be used in execution of the programs. The volatile storage medium is a random access memory (RAM), for example. The volatile storage medium is used as a work area of the CPU 11, a data storage area, and a data buffer area for communication.

The communication IF 13 includes a communication circuit that controls data transmission and reception processing. The communication IF 13 is a local area network (LAN) card or a network interface card (NIC), for example. The input device 14 is used to input data. The input device 14 includes keys, buttons, a pointing device (such as a mouse), a touch panel, and the like, for example. The output device 15 is used to output data. The output device 15 is a display device, for example.

The CPU 11 performs various kinds of processing by loading the programs stored in the non-volatile storage medium in the memory 12 onto the volatile storage medium and executing the programs. More specifically, the information processor 10 operates as the IPS 3, the S-GW 7, the P-GW 8, and the MME 6, respectively, by the CPU 11 executing the programs stored in the memory 12. Note that at least two of the S-GW 7, the P-GW 8, and the MME 6 may be mounted on one information processor 10.

When the information processor 10 is used as the IPS 3, the memory 12 stores a program for performing processing as the IPS 3 and information (determination information) for determining an attack communication flow. The determination information includes information indicating a packet reception pattern recognized as the attack communication flow. The CPU 11 executes the program to monitor a packet reception pattern for each flow received by the communication IF 13, for example, and match with a determination reception pattern stored in the memory 12. When a packet reception pattern of a certain flow matches with the determination reception pattern, the CPU 11 detects the certain flow as the attack communication flow. Then, the CPU 11 transmits specification information (source and destination port numbers and source and destination IP addresses) of the flow to the P-GW 8. The memory 12 previously stores an address of the P-GW 8.

When the information processor 10 is used as the MME 6, the memory 12 stores a program for performing processing as the IPS 3 and data to be used in execution of the program. The CPU 11 executes the program to handle a control plane (C plane) and perform location registration of the terminal 4 wirelessly coupled to the base station 5. Also, the MME 6 executes the program to control setting of a bearer associated with the terminal 4 wirelessly coupled to the base station 5. For the control of the bearer setting, the CPU 11 performs processing for generating a control message to the S-GW 7 or the base station 5 and transmitting the control message from the communication IF 13.

When the information processor 10 is used as the S-GW 7, the memory 12 stores a program for performing processing as the S-GW 7 and data to be used in execution of the program. In response to a request from the MME 6 or the P-GW 8, the CPU 11 performs processing of setting a bearer (GTP tunnel) or processing of sending an encapsulated packet received through a bearer to the corresponding bearer by referring to a TEID of the packet, and the like. Moreover, when the block function is provided in the S-GW 7, the memory 12 stores a program for executing the block function. The CPU 11 executes the program to perform processing of discarding a packet having a TEID corresponding to the attack communication flow or transferring a packet to a packet terminal device different from the P-GW 8.

When the information processor 10 is used as the P-GW 8, the memory 12 stores a program for performing processing as the P-GW 8 and data to be used in execution of the program. The CPU 11 performs processing of decapsulating the encapsulated packet received from the S-GW 7 through the bearer and then transferring the packet to the IPS 3 (company network 2) according to the destination IP address of the packet. Moreover, upon receipt of information (also called “blocking flow information”) for specifying an attack communication flow to be blocked from the IPS 3, the CPU 11 performs processing of transmitting a request to generate a blocking bearer to the S-GW 7.

<Hardware Configuration of Base Station>

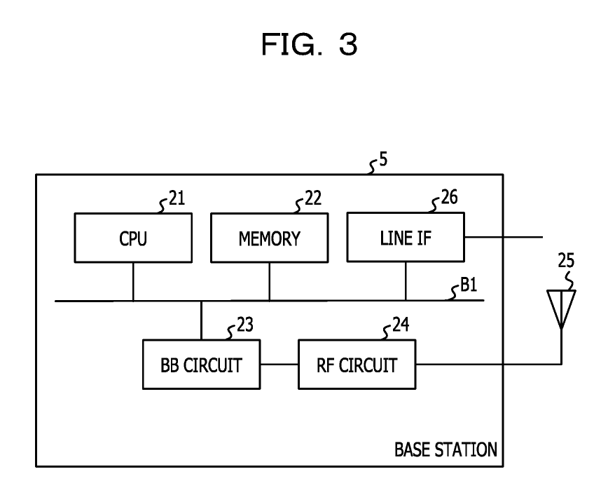

FIG. 3 illustrates a hardware configuration example of the base station 5. In FIG. 3, the base station 5 includes a CPU 21, a memory 22, a baseband (BB) circuit 23, and a line interface (line IF) 26, which are coupled to each other through a bus B1. A radio frequency (RF) circuit 24 is coupled to the BB circuit 23. An antenna 25 is coupled to the RF circuit 24.

The same configuration as that of the memory 12 may be adopted for the memory 22. A volatile storage medium in the memory 22 is used as a work area of the CPU 21, a program execution area, and a data buffer area. A non-volatile storage medium in the memory 22 stores programs to be executed by the CPU 21 and data to be used in execution of the programs.

The line IF 26 is formed using a LAN card or an NIC, for example. The line IF 26 may include a network processor (NP). The line IF 26 accommodates a physical line coupled to the MME 6 or another base station 5 (not illustrated). An S1 line, an X2 line, and a GTP-U line are provided on the physical line. The S1 line (S1 interface) includes an S1-MME interface and an S1-U interface. The S1-MME interface is an interface between the base station 5 and the MME 6. The S1-U interface is an interface between the base station 5 and the S-GW 7. The GTP-U (GTP tunnel) is generated on the S1-U interface. Note that the X2 line (X2 interface) is an interface between the base stations 5.

The BB circuit 23 performs digital baseband processing associated with radio communication with the terminal 4. More specifically, the BB circuit 23 generates a baseband signal by performing coding and modulation processing of data to the terminal 4. Also, the BB circuit 23 acquires data by performing demodulation and decoding processing of the baseband signal received from the RF circuit 24. The BB circuit 23 may be formed using at least one of a digital signal processor (DSP), a programmable logic device (PLD) such as a field programmable gate array (FPGA), and an integrated circuit (IC, LSI, application specific integrated circuit (ASIC) and the like), for example.

The RF circuit 24 uses the BB circuit 23 to convert the baseband signal into an RF signal (radio wave), and transmits the RF signal from the antenna 25. Meanwhile, an RF signal (radio wave) received by the antenna 25 is converted into a baseband signal by the RF circuit 24, and the baseband signal is inputted to the BB circuit 23.

The CPU 21 loads and executes the program stored in the memory 22. Thus, the CPU 21 performs processing as the base station 5. For example, the CPU 21 is wirelessly coupled to the terminal 4 by following procedures for random access to the terminal 4. Also, the base station 5 (CPU 21) sets a radio bearer through message exchange with the terminal 4. Moreover, the base station 5 (CPU 21) performs protocol conversion of control information received from the terminal 4, and transmits the information to the MME 6. Furthermore, the base station 5 (CPU 21) performs protocol conversion of a packet received from the terminal 4 through the radio bearer, and transmits the packet to the S-GW 7 through the bearer to the S-GW 7.

<Hardware Configuration of Terminal>

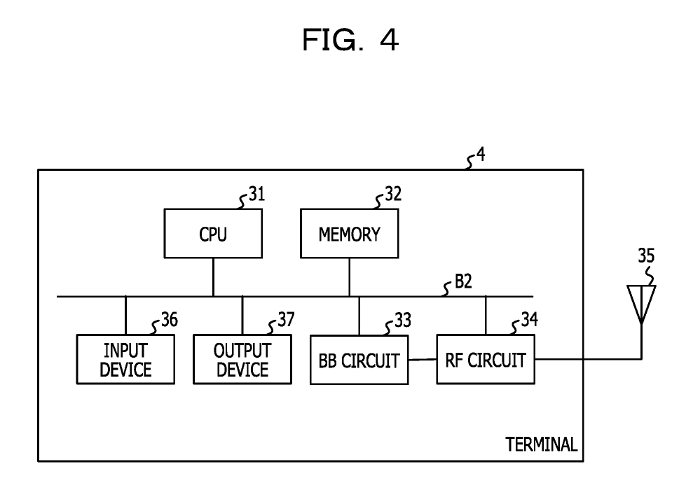

FIG. 4 illustrates a hardware configuration example of the terminal 4. In FIG. 4, the terminal 4 includes a CPU 31, a memory 32, a BB circuit 33, an input device 36, and an output device 37, which are coupled to each other through a bus B2. An RF circuit 34 is coupled to the BB circuit 33. An antenna 35 is coupled to the RF circuit 34.

The same configuration as that of the memory 12 may be adopted for the memory 32. A volatile storage medium in the memory 32 is used as a work area of the CPU 31, a program execution area, and a data buffer area. A non-volatile storage medium in the memory 32 stores programs to be executed by the CPU 31 and data to be used in execution of the programs.

The same configurations as those of the BB circuit 23, the RF circuit 24, and the antenna 25 may be adopted as the configurations of the BB circuit 33, the RF circuit 34, and the antenna 35. The same configurations as those of the input device 14 and the output device 15 may be adopted for the input device 36 and the output device 37. Note that the input device 36 includes a voice input device such as a microphone, and the output device 37 includes a voice output device such as a speaker.

The CPU 31 performs processing as the terminal 4 by executing the program stored in the memory 32. The processing as the terminal 4 includes processing of wirelessly coupling to the base station 5, processing of performing location registration through the base station 5, processing of setting a radio bearer between the terminal 4 and the base station 5, processing of generating and transmitting a packet to the company network 2, processing of receiving a packet from the company network 2, and the like.

Note that the CPUs 11, 21, and 31 are an example of a “processor”, “controller”, “control unit”, and “controller”, respectively. The memories 12, 22, 32 are an example of a “storage device” and “storage medium”, respectively. The communication IF 13 and the line IF 26 are an example of a “communication unit”, respectively. Moreover, the CPUs 11, 21, and 31 executes the program to operate as the “block unit configured to perform processing of blocking an attack communication flow transferred through a blocking communication path (bearer)”.

Moreover, at least a part of processing executed by each of the CPUs 11, 21, and 31 may be performed using a DSP. Alternatively, at least a part of processing executed by each of the CPUs 11, 21, and 31 may be performed using a semiconductor device such as a PLD and an integrated circuit.

<Operation Example>

With reference to FIG. 1, an operation example according to Embodiment 1 is described. When the terminal 4 accesses the company network 2, the terminal 4 is wirelessly coupled to the base station 5 for location registration in the mobile network 1. The location registration is performed by the MME 6 registering information on the terminal 4 with a home subscriber server (HSS, not illustrated). The HSS is a server handling service control and subscriber data.

When the location registration is performed, a communication path (bearer) is set between the terminal 4 and the P-GW 8 under the control of the MME 6. Thus, in the mobile network 1 (LTE network), the bearer is set between the terminal 4 and the P-GW 8 to transfer a user packet. In the mobile network 1, a plurality of bearers may be set between the terminal 4 and the P-GW 8. The bearer set (generated) upon the location registration is called a Default Bearer. One or more bearers different from the Default Bearer may be set (generated) between the terminal 4 and the P-GW 8. The bearer different from the Default Bearer is called a Dedicated Bearer and dependent on the Default Bearer.

The terminal 4 identifies a bearer, through which a packet is transferred flow by flow, based on a traffic flow template (TFT), and distributes packets to the corresponding bearer. The packet transmitted from the terminal 4 is transferred through the corresponding bearer. The packet is relayed by the base station 5 and the S-GW 7 and reaches the P-GW 8. The P-GW 8 transmits the packet to the company network 2.

The IPS 3 monitors behavior (reception status) of the packet to the company network 2 from the terminal 4, and detects an attack communication flow by determining whether or not a flow of the packet is the attack communication flow (<1> in FIG. 1). When the attack communication flow is detected, the IPS 3 transmits specification information (blocking flow information) of the attack communication flow to the gateway (P-GW 8 in the example of FIG. 1) in the mobile network 1 (<2> in FIG. 1).

Upon receipt of the blocking flow information, the P-GW 8 transmits a message instructing setting of a bearer for blocking the attack communication flow in the mobile network 1 to the S-GW 7 (<3A> in FIG. 1). In response to the bearer setting instruction, the S-GW 7, the MME 6, the base station 5, and the terminal 4 set bearers for blocking (blocking bearers) between the terminal 4 and the P-GW 8 through the base station 5 and the S-GW 7 (<3B> in FIG. 1).

In setting of the blocking bearers, the S-GW 7 recognizes an identifier (TEID) of each of the blocking bearers. Moreover, in setting of a blocking radio bearer between the terminal 4 and the base station 5, the terminal 4 makes a change to the setting (sets a TFT filter) to transmit a packet of the attack communication flow to the blocking bearer rather than an existing bearer.

Therefore, the terminal 4 transmits the packet of the attack communication flow to the blocking bearer (<4> in FIG. 1). Upon receipt of a packet (encapsulated packet having a TEID of the blocking bearer) that has reached the S-GW 7 through the blocking bearer, the S-GW 7 discards the packet. Thus, the attack communication flow is blocked in the mobile network 1.

With the configuration illustrated in FIG. 1, when the IPS 3 (protection device) of the company network 2 blocks an attack communication flow in the mobile network 1, the flow is determined by the identifier (TEID: referring to information in the GTP-U layer) of the blocking bearer. Thus, the IP layer or higher layers in a relay device (also called a “relay node”) within the mobile network may no longer referred to. In other words, determination of whether to discard a packet in the block unit and transfer of a packet to a device other than the P-GW 8 are enabled by referring to the bearer identifier in the layer lower than the IP layer. Therefore, the amount of functions added to realize blocking of the flow in the mobile network 1 is reduced, and an increase in load on a device provided with a block function is avoided. Moreover, the load on the IPS 3 is reduced since the packet of the attack communication flow is avoided from being transferred to the company network 2 from the mobile network 1.

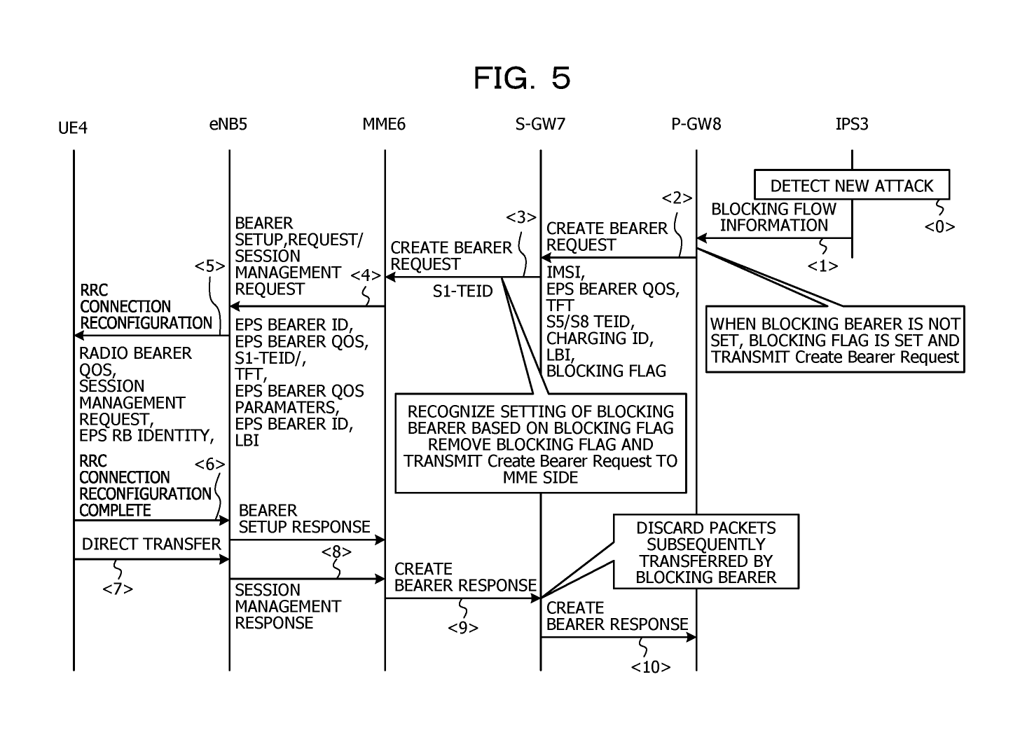

FIG. 5 is a sequence diagram illustrating a specific processing example of Operation Example 1. The sequence illustrated in FIG. 5 illustrates a procedure for setting a new blocking bearer different from the existing bearer (Default Bearer) set between the terminal 4 and the P-GW 8. The blocking bearer is generated by following the procedure for generating the Dedicated Bearer.

The blocking bearer setting procedure illustrated in FIG. 5 is based on Dedicated Bearer Activation procedure specified in 3GPP TS 23.401 §5.4.1. The bold-face characters in FIG. 5 (except for “blocking flow information” of <1> in FIG. 5) indicate control signals (messages) specified in TS 23.401, while fine characters (italic-face characters) indicate fields (information element groups) or information elements included in each of the messages.

In FIG. 5, when the IPS 3 detects a new attack communication flow (<0> in FIG. 5), the IPS 3 transmits blocking flow information to the P-GW 8 (<1> in FIG. 5). The address of the P-GW 8 is known to the IPS 3.

Upon receipt of the blocking flow information, the P-GW 8 determines whether or not a blocking bearer is already generated. In this event, when no blocking bearer is generated, the P-GW 8 generates (issues) a message (control signal) “Create Bearer Request” to request setting of the blocking bearer, and transmits the message to the S-GW 7. The memory 12 in the P-GW 8 stores an address of the S-GW 7, and the P-GW 8 uses the address to transmit “Create Bearer Request” (<2> in FIG. 5). The message “Create Bearer Request” is an example of a “blocking communication path setup request”.

“Create Bearer Request” includes International Mobile Subscriber Identity (IMSI), evolved packet system (EPS) Bearer QoS parameter, traffic flow template (TFT) field, S5/S8-TEID, Charging ID, linked eps bearer identity (LBI), and a blocking flag.

The IMSI is an identification number of the terminal 4. The EPS Bearer QoS parameter indicates a parameter associated with quality of service (QoS) of the blocking bearer. For example, the EPS Bearer QoS parameter specifies the priority (transfer priority) of the blocking bearer with respect to the Default Bearer. By specifying the transfer priority, a transmission rate of a packet transferred through the blocking bearer is set lower than a transmission rate of a packet transferred through a bearer other than the blocking bearer. The TFT field is an information structure set used to map a service data flow (attack communication flow) on a specific bearer. The P-GW 8 sets information on a flow to be blocked, of which the TFT field is notified by the IPS.

The S5/S8-TEID is an identifier of a GTP tunnel of the S5/S8 interface (interface between the S-GW 7 and the P-GW 8). The GTP tunnel forms a blocking bearer between the S-GW 7 and the P-GW 8. The blocking bearer between the S-GW 7 and the P-GW 8 is identified by the S5/S8-TEID assigned by the P-GW 8. A Charging ID is an ID for charging (charging ID). Note that, when the P-GW 8 is provided with no blocking function, a dummy (not actually used) S5/S8-TEID and Charging ID may be set in “Create Bearer Request”.

The LBI is an identifier (ID) of an existing bearer between the terminal 4 and the P-GW 8, that is, a bearer (Default Bearer) corresponding to the Dedicated Bearer (blocking bearer). A blocking flag is information indicating that “Create Bearer Request” is a blocking bearer setup request. Note that the blocking flag is an optional information element not specified in TS 23.401.

Upon receipt of “Create Bearer Request” (blocking bearer setup request), the S-GW 7 refers to the blocking flag in “Create Bearer Request” and recognizes that the “Create Bearer Request” is the blocking bearer setup request. Then, the S-GW 7 removes the blocking flag from “Create Bearer Request” and transmits “Create Bearer Request” to the MME 6 (<3> in FIG. 5).

“Create Bearer Request” to the MME 6 is generated by the P-GW 8 mapping the respective pieces of information (except for the blocking flag) in “Create Bearer Request” in respective fields of a Create Bearer Request signal to be transmitted to the MME 6. Note that the memory 12 in the S-GW 7 stores an address of the MME 6, and the S-GW 7 uses the address to transmit “Create Bearer Request”. In this event, the S-GW 7 includes an S1-TEID to be assigned to the blocking bearer in “Create Bearer Request”. The S1-TEID is an identifier of a GTP tunnel forming a blocking bearer set on the S1-U interface between the base station 5 and the S-GW 7. The blocking bearer between the base station 5 and the S-GW 7 is identified by the S1-TEID.

Upon receipt of “Create Bearer Request”, the MME 6 generates a message “Bearer Setup Request/Session Management Request” for the base station (eNB) 5 and the terminal (UE) 4 to set the Dedicated Bearer, and transmits the message to the base station 5 (<4> in FIG. 5). The memory 12 in the MME 6 stores an address of the base station 5, and the MME 6 uses the address to transmit the message to the base station 5. “Bearer Setup Request” is a bearer setup request to the base station 5. “Session Management Request” is a radio bearer setup request to the terminal 4.

The message “Bearer Setup Request” includes an EPS Bearer Identity (EPS Bearer ID: referred to as a “bearer ID”), an EPS Bearer QoS parameter, and an S1-TEID. The EPS Bearer ID is an identifier of the blocking bearer (Dedicated Bearer). The MME 6 assigns an ID, which is not assigned to the terminal 4, to the blocking bearer as the EPS Bearer ID.

The EPS Bearer QoS parameter and the S1-TEID are information included in “Create Bearer Request”. The message “Session Management Request” includes a TFT field, an EPS Bearer QoS parameter, an EPS Bearer ID, and an LBI. The TFT field, the EPS Bearer QoS parameter, and the LBI are information included in “Create Bearer Request”. The EPS Bearer ID (bearer ID) is the same ID as the ID included in “Bearer Setup Request”.

The base station 5 maps the EPS bearer QoS parameter on Radio Bearer QoS (QoS of the radio bearer). The base station 5 transmits a message “radio resource control (RRC) Connection Reconfiguration” including a Radio Bearer QoS parameter, an EPS RB identity (EPS RB ID), and “Session Management Request” to the terminal 4 using a radio link established between the base station 5 and the terminal 4 (<5> in FIG. 5). The EPS RB identity (EPS RB ID) is an identifier of the radio bearer, and is assigned to the radio bearer forming the blocking bearer by the base station 5.

Upon receipt of “RRC Connection Reconfiguration”, the terminal 4 stores the QoS information and the packet flow ID included in “Session Management Request” for use during access to the mobile network 1. Also, the terminal 4 stores the EPS Bearer ID and the EPS RB Identity in association with each other, and associates (links) the Default Bearer with the blocking bearer according to the LBI. Moreover, the terminal 4 performs setting for distributing an attack communication flow specified by the TFT field to the blocking bearer as setting of a TFT uplink (UL) filter (filter for distributing flows from the terminal 4 to a plurality of bearers). In this event, the terminal 4 sets the setting (priority) based on the EPS Bearer QoS parameter to the blocking bearer. For example, the priority of a packet of an attack flow transferred to the blocking bearer is set lower than that of a packet of a normal flow that is not the attack flow. As a result, a transmission rate of the packet of the attack flow from the terminal 4 is set lower than a transmission rate of the packet of the normal flow. Thus, a transfer priority of the packet of the attack flow within the mobile network 1 is lowered, and the influence of transfer of the packet of the attack flow on the normal flow (delay of the packet of the normal flow in the mobile network 1, compression of a communication band, and the like) is suppressed or avoided.

The terminal 4 transmits a response message “RRC Connection Reconfiguration Complete” to “RRC Connection Reconfiguration” to the base station 5, and the base station 5 confirms activation of the radio bearer forming the blocking bearer (<6> in FIG. 5). The base station 5 stores at least the bearer ID (EPS Bearer ID), the radio bearer ID (EPS RB ID), and the S1-TEID in association with each other. The stored information is used by the base station 5 to encapsulate a packet received from the radio bearer specified by the radio bearer ID by using a header including the S1-TEID, and to transfer the encapsulated packet to the S-GW 7.

The base station 5 sends a message “Bearer Setup Response” to the MME 6 to notify the MME 6 of the activation of the blocking bearer. “Bearer Setup Response” includes the EPS Bearer ID and the S1-TEID, and the MME 6 uses such information to specify the activated bearer.

A non-access stratum (NAS) layer in the terminal 4 generates a response message “Session Management Response” to “Session Management Request” including the EPS Bearer ID. The terminal 4 uses a radio link to transmit “Session Management Response” to the base station 5 (Direct Transfer: <7> in FIG. 5). The base station 5 transmits “Session Management Response” to the MME 6 (<8> in FIG. 5). The address of the MME 6 is known to the base station 5.

The MME 6 confirms the activation of the bearer (blocking bearer) specified by the EPS Bearer ID and the S1-TEID by transmitting a message “Create Bearer Response” including the EPS Bearer ID, the S1-TEID, and user location information (ECGI) to the S-GW 7 (<9> in FIG. 5).

Upon receipt of “Create Bearer Response”, the S-GW 7 confirms the activation of the blocking bearer, and transmits a message “Create Bearer Response” including the EPS Bearer ID, the S5/S8-TEID, and the ECGI to the P-GW 8 (<10> in FIG. 5). The S-GW 7 stores the bearer ID, the S1-TEID, and the blocking flag in the memory 12 in association with each other. Thereafter, the S-GW 7 performs blocking processing on a packet (packet with the S1-TEID to be blocked) transferred through the blocking bearer, by referring to the stored information.

The P-GW 8 stores at least the EPS Bearer ID in “Create Bearer Response” in the memory 12 as the identifier of the blocking bearer. Thereafter, the P-GW 8 determines whether or not there is the EPS Bearer ID stored as the identifier of the blocking bearer, thereby determining whether or not the blocking bearer is already set upon receipt of the blocking flow information from the IPS 3.

Thus, in Embodiment 1, the P-GW 8 sets the flow information to be blocked in the TFT of “Create Bearer Request” and includes the blocking flag therein, thereby setting (creating) a blocking bearer in the mobile network 1 to execute blocking processing on the packet of the flow to be blocked in the S-GW 7.

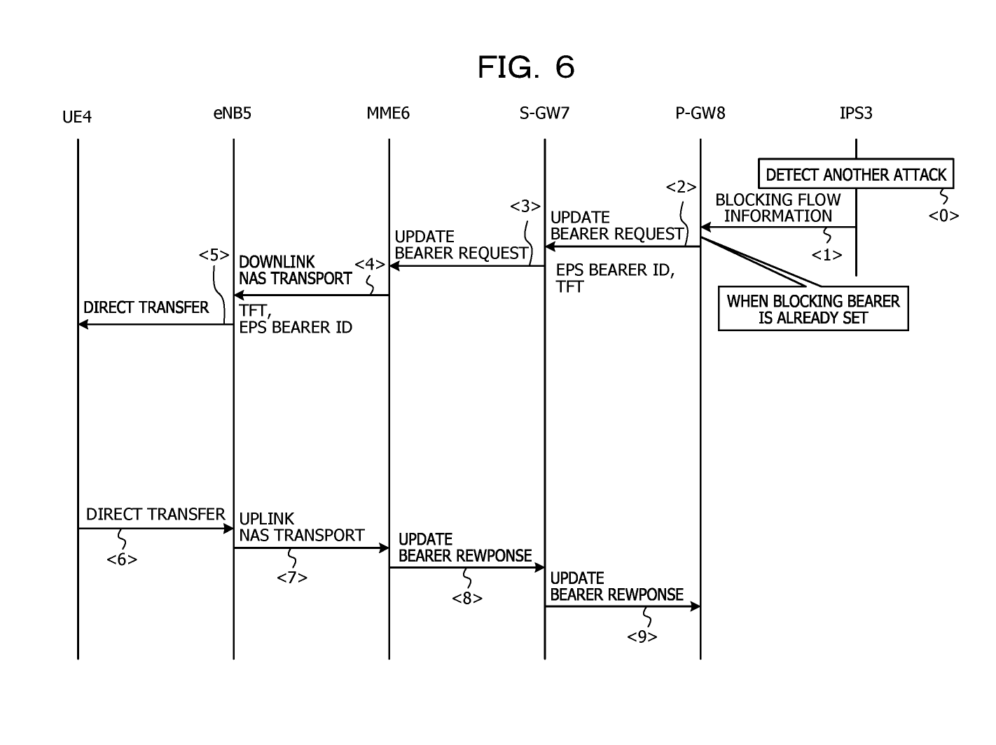

FIG. 6 is a sequence diagram illustrating an operation example (Operation Example 2) when the IPS 3 detects another attack communication flow when the blocking bearer is already set. The sequence is the same procedure as LTE bearer modification (without bearer QoS update) procedure (PDN GW initiated) in 3GPP TS 23.401 §5.4.3.

In FIG. 6, when the IPS 3 detects another (new) attack communication flow (attack flow) (<0> in FIG. 6), the IPS 3 transmits attack communication flow information (blocking flow information) that is specification information of the new attack communication flow to the P-GW 8 (<1> in FIG. 6). Upon receipt of the flow information, the P-GW 8 determines whether or not the blocking bearer information (at least the EPS Bearer ID) is stored in the memory 12. In this event, when the blocking bearer information is stored in the memory 12, the P-GW 8 determines that the blocking bearer is already set.

When the blocking bearer is already set, the P-GW 8 transmits a blocking bearer update request message “Update Bearer Request” to the S-GW 7 (<2> in FIG. 6). “Update Bearer Request” includes an EPS Bearer ID (blocking bearer identifier) and a TFT field. In the TFT field, the another (new) flow information to be blocked obtained from the IPS 3 is set. Moreover, the blocking bearer update request message is an example of a message requesting a new attack communication flow packet to be transferred through the blocking bearer using the attack communication flow information.

The S-GW 7 transmits “Update Bearer Request” to the MME 6 (<3> in FIG. 6). The MME 6 generates a message “Downlink NAS Transport” to the terminal 4 including the TFT field and the EPS Bearer ID in “Update Bearer Request”, and transmits the message to the base station 5 (<4> in FIG. 6). The base station 5 transmits “Downlink NAS Transport” to the terminal 4 through radio communication (Direct Transfer: <5> in FIG. 6).

The terminal 4 refers to the EPS Bearer ID and the TFT field in “Downlink NAS Transport” to perform setting of distributing flows specified by the TFT field to the blocking bearer by using a TFT UL filter. Thereafter, the terminal 4 transmits a response message “Uplink NAS Transport” to “Downlink NAS Transport” to the base station 5 through radio communication (Direct Transfer: <6> in FIG. 6). The base station 5 transmits “Uplink NAS Transport” to the MME 6 (<7> in FIG. 6).

The MME 6 confirms that the flow is transferred through the blocking bearer, based on at least the EPS Bearer ID in “Uplink NAS Transport”, and transmits a message “Update Bearer Response” to the S-GW 7 (<8> in FIG. 6). The S-GW 7 confirms that the bearer is updated (the number of flows to be transferred through the blocking bearer) based on at least the EPS Bearer ID in “Update Bearer Response”, and transmits “Update Bearer Response” to the P-GW 8 (<9> in FIG. 6).

Thus, when the blocking bearer is already set upon detection of another attack flow, the procedure for transferring the attack flow through the set blocking bearer. Accordingly, a plurality of attack flows may be set to the existing blocking bearer.

<Processing in P-GW 8>

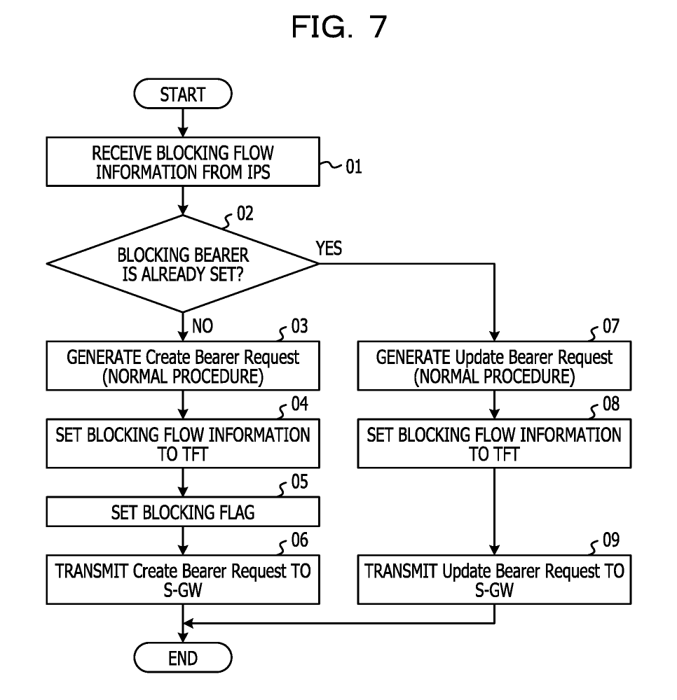

FIG. 7 is a flowchart illustrating a processing example in the P-GW 8. The processing in FIG. 7 is executed by the CPU 11 in the information processor 10 operating as the P-GW 8. The processing in FIG. 7 is started when the CPU 11 receives the flow information to be blocked (blocking flow information), which is transmitted from the IPS 3, through the communication IF 13.

In “01”, the CPU 11 receives attack communication flow information to be blocked (blocking flow information) from the IPS 3. In “02”, the CPU 11 determines whether or not a blocking bearer is already set. This determination is made by determining whether or not information on the blocking bearer (the EPS Bearer ID and the like of the blocking bearer) is stored in the memory 12.

When the blocking bearer is already set (“02”; Y), the processing advances to 07. On the other hand, when the blocking bearer is not set (“02”; N), the processing advances to “03”. In “03”, the CPU 11 generates a message “Create Bearer Request”. In “04”, the CPU 11 sets the blocking flow information in the TFT field in “Create Bearer Request”. In “05”, the CPU 11 sets a blocking flag in “Create Bearer Request”. The order of processing of “04” and “05” may be reversed. In “06”, the CPU 11 transmits “Create Bearer Request” to the S-GW 7 through the communication IF 13.

When the processing advances to “07”, the CPU 11 generates a message “Update Bearer Request”. In “08”, the CPU 11 sets the blocking flow information in the TFT field of “Update Bearer Request”. In “09”, the CPU 11 transmits “Update Bearer Request” to the S-GW 7 through the communication IF 13.

<Processing in S-GW>

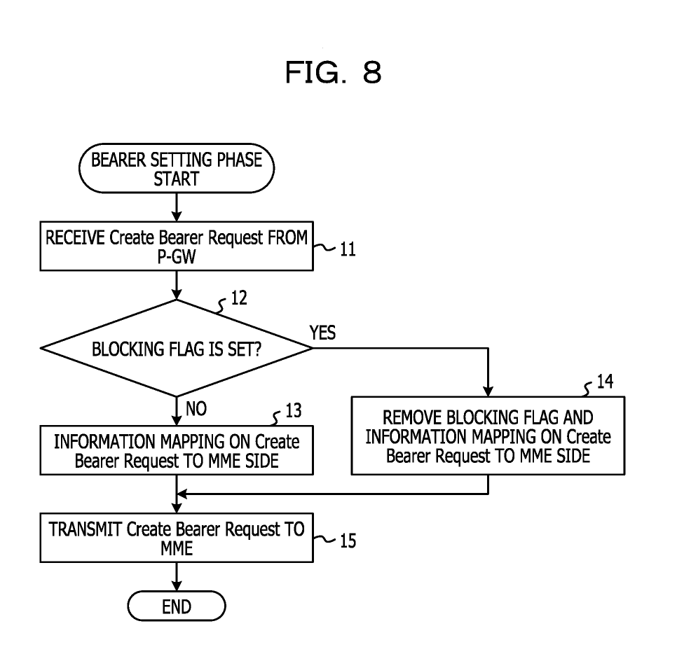

FIG. 8 is a flowchart illustrating a processing example in a blocking bearer setup phase in the S-GW 7. The processing illustrated in FIG. 8 is executed by the CPU 11 in the information processor 10 operating as the S-GW 7.

In “11”, the CPU 11 receives “Create Bearer Request” through the communication IF 13. In “12”, the CPU 11 determines whether or not a blocking flag is set in “Create Bearer Request”. When the blocking flag is set (“12”; Y), the processing advances to “14”. On the other hand, when no blocking flag is set (“12”; N), the processing advances to “13”.

When the processing advances to “13”, the CPU 11 maps the information in “Create Bearer Request” received from the P-GW 8 onto “Create Bearer Request” on the MME 6 side. When the processing advances to “14”, the CPU 11 removes the blocking flag from “Create Bearer Request” received from the P-GW 8, and maps the rest of the information onto “Create Bearer Request” on the MME 6 side. In “15”, the CPU 11 transmits “Create Bearer Request” generated by the processing of “13” or “14” to the MME 6 through the communication IF 13.

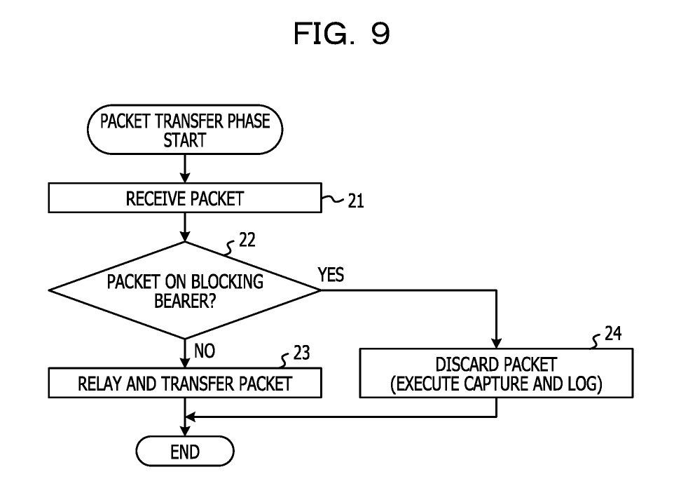

FIG. 9 is a flowchart illustrating a processing example in a packet transfer phase in the S-GW 7. The processing illustrated in FIG. 9 is executed by the CPU 11 in the information processor 10 operating as the S-GW 7.

In “21”, the CPU 11 receives a packet through the communication IF 13. In “22”, the CPU 11 determines whether or not the received packet is a packet on the blocking bearer. This determination is made by determining whether or not a TEID assigned to the packet is the S1-TEID of the blocking bearer, for example.

When the received packet is not the packet on the blocking bearer (“22”; N), the CPU 11 transfers the packet to a corresponding bearer (bearer having the S5/S8-TEID corresponding to the S1-TEID) through the communication IF 13 (“23”). On the other hand, when the received packet is the packet on the blocking bearer (“22”; Y), the CPU 11 discards the packet (“24”). In this event, the CPU 11 may capture the packet instead of discarding the packet. Furthermore, the CPU 11 may log the packet. As described above, the CPU 11 operates as the “block unit”.

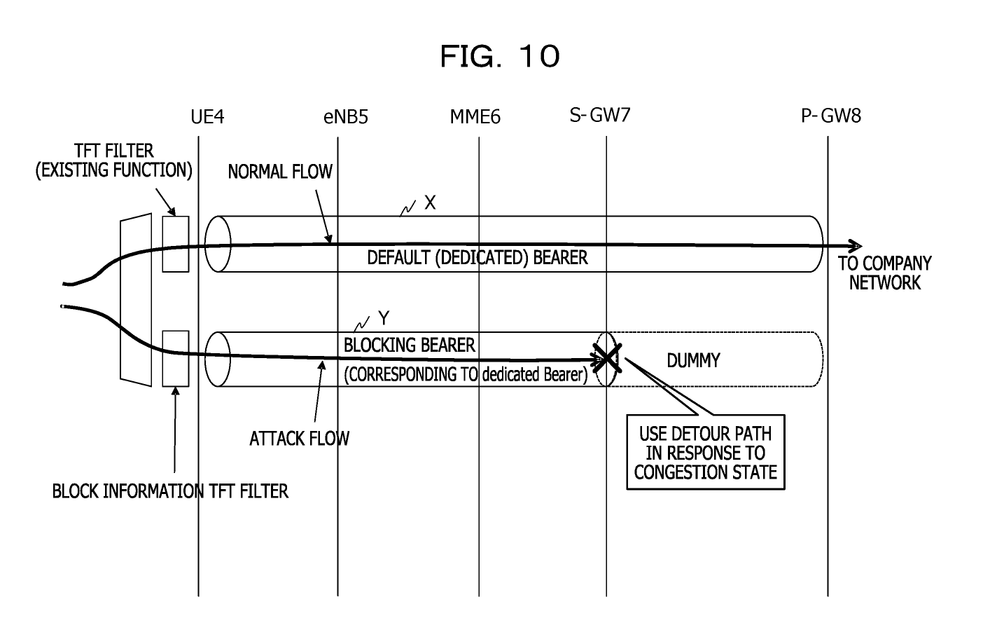

FIG. 10 schematically illustrates packet transfer to the P-GW 8 from the terminal (UE) 4. In Embodiment 1, a bearer X that is a Default Bearer (sometimes a Dedicated Bearer is set) for transferring a packet of a normal flow (flow that is not an attack flow) and a blocking bearer Y for transferring a packet of an attack flow.

In the terminal 4, a TFT filter is set to transfer the packet of the normal flow to the bearer X. Moreover, a TFT filter is set to transfer the packet of the attack flow to the blocking bearer Y. The packets of the respective flows are transferred to the base station 5 from the terminal 4 through the radio bearer. The base station 5 terminates the radio bearer, encapsulates a packet using a header including the S1-TEID corresponding to the radio bearer ID, and transfers the packet to the S-GW 7. In the normal flow, the S-GW 7 terminates the bearer between the base station 5 and the S-GW 7, encapsulates a packet using a header including the S5/S8-TEID corresponding to the S1-TEID, and transmits the packet to the P-GW 8. The P-GW 8 terminates the bearer, decapsulates the packet, and transfers the packet to the company network 2.

When reaching the S-GW 7, the packet of the attack flow is discarded in the S-GW 7 without being transferred to the P-GW 8. Thus, the packet of the attack flow is avoided from being transmitted to the company network 2 from the P-GW 8. As a result, attack by the packet of the attack flow on the company network 2 is avoided. Moreover, the IPS 3 only transmits the flow information to the P-GW 8, and does not perform any processing on the attack flow. Thus, the processing load on the IPS 3 is reduced.

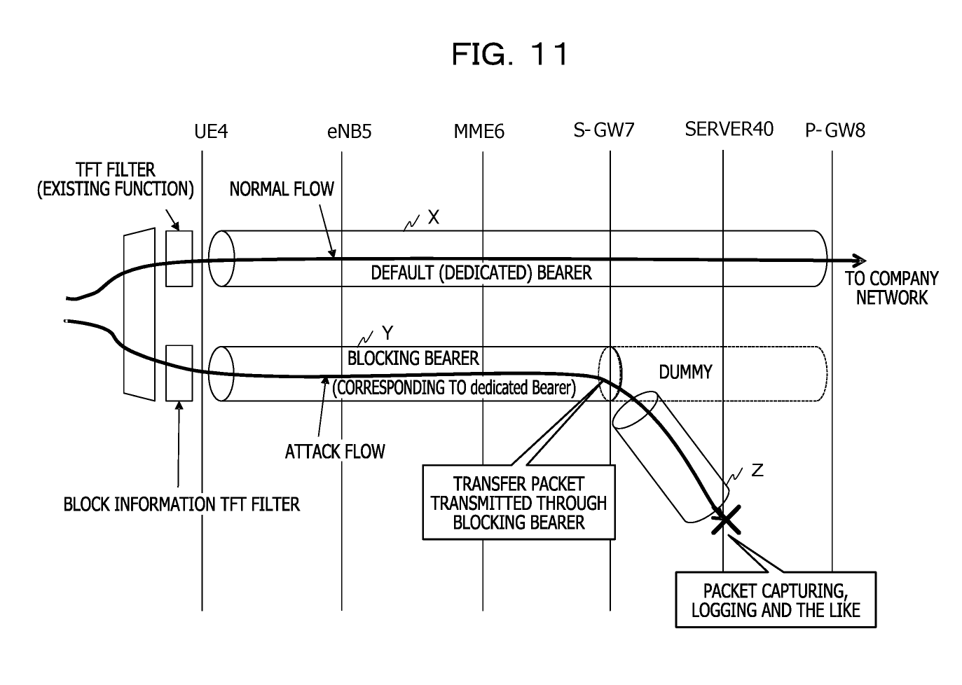

FIG. 11 illustrates a modified example of Embodiment 1. In FIG. 11, a server 40 that is a packet collector is provided, and a bearer Z is provided between the S-GW 7 and the server 40. The server 40 is an example of a “packet termination device”. The server 40 captures and logs a packet of an attack flow received from the S-GW 7. The server 40 may discard the packet.

In the modified example, upon receipt of a packet of an attack flow, the S-GW 7 transfers the packet to the bearer set between the S-GW 7 and the server 40. The packet of the attack flow is avoided from being transmitted to the company network 2 as in the case of the example of FIG. 10 by the server 40 capturing the packet. A computer having the hardware configuration of the information processor 10 may be used as the server 40. Note that two blocking bearers may be set to discard a packet of one of the blocking bearers and transfer a packet of the other blocking bearer to the server 40 by distributing packets to the blocking bearers for each attack flow. As for one attack communication flow, discarding of a packet and transfer thereof to the server 40 may be selectively executed based on conditions previously set by a contract between a carrier of the company network and a carrier of the mobile network. However, the conditions may be predetermined conditions other than those set by the contract between the carriers.

<Effects of Embodiment 1>

According to Embodiment 1, the blocking bearer is generated in the mobile network 1 to block the attack flow detected by the IPS 3 in the mobile network 1, and the attack flow packet is transferred through the blocking bearer. The block function (block point) is set in the S-GW 7 to discard the packet transferred through the blocking bearer. In this event, the S-GW 7 refers to the S1-TEID to determine whether or not the packet is discarded or transferred to a device for discarding the packet. More specifically, information on the IP layer or higher layers may not be referred to for flow determination. Thus, the amount of functions added to realize the block function may be reduced, and an increase in load on a relay device (relay node) with the block function may be avoided. Moreover, the load on the IPS 3 is reduced since the packet of the attack flow is avoided from being transmitted to the company network 2.

Moreover, in Embodiment 1, the description is given of the example where the block function (block unit) is provided in the S-GW 7. However, the block function (block unit) may be provided in the base station 5 or the P-GW 8, which is another relay device in the mobile network 1. Alternatively, the block function may be provided in the terminal 4.

For example, when the block function is provided in the P-GW 8, the CPU 11 in the information processor 10 operating as the P-GW 8 operates as the block unit (performs the processing in FIG. 9). For example, the P-GW 8 may store the S5/S8-TEID corresponding to the blocking bearer (specified by the bearer ID), and discard a packet including the S5/S8-TEID upon receipt of the packet. Alternatively, after decapsulation of the packet, the P-GW 8 may refer to the TCP/IP header of the packet and discard the packet if the flow is the attack flow. In this case, no blocking flag may be set in “Create Bearer Request” transmitted from the P-GW 8. The blocking flag is information for notifying the device serving as the block point of the fact that the bearer to be set is the blocking bearer.

When the block function is provided in the base station 5, for example, the base station 5 may discard a packet transferred through the blocking bearer (provided with the S1-TEID of the blocking bearer). The CPU 21 in the base station 5 performs the same processing as that illustrated in FIG. 9 as the block unit. Alternatively, the base station 5 may discard a packet received through a radio bearer of the blocking bearer. In this case, the blocking flag is not removed in the S-GW 7 but mapped onto “Create Bearer Request” to the MME 6. The MME 6 maps the blocking flag onto “Bearer Setup Request”. The base station 5 recognizes that the bearer to be set is the blocking bearer by referring to the blocking flag. Moreover, in this case, the bearer between the base station 5 and the S-GW 7 may be set as a dummy.

When the block function is provided in the terminal 4, the blocking flag is not removed in the S-GW 7 but mapped onto “Create Bearer Request” to the MME 6. The MME 6 maps the blocking flag onto “Session Management Request”. The terminal 4 recognizes that the bearer to be set is the blocking bearer by referring to the blocking flag. The terminal 4 discards a packet outputted from the TFT filter corresponding to the blocking bearer, for example. The CPU 31 in the terminal 4 operates as the block unit.

### Embodiment 2

Embodiment 2 is described below. Since a configuration of Embodiment 2 includes similarities to Embodiment 1, differences are mainly described and description of the similarities is omitted.

Blocking flow information provided from the IPS (protection device) 3 of the company network 2 may correspond to all communications from the terminal 4 to the company network 2. For example, there is a case where a source IP address included in the blocking flow information is an address of the terminal 4, a destination IP address is a network address of the company network 2, and TCP source and destination port numbers are arbitrary. Alternatively, there is a case where all communications from the terminal 4 to the company network 2 are blocked when an attack flow is detected based on a contract with a user (user of the terminal 4). In such cases, the Default Bearer between the P-GW 8 and the terminal 4 is released.

In Embodiment 2, when the blocking flow information received from the IPS 3 by the P-GW 8 is flow information covering all flows to be transferred through the Default bearer, which meets the conditions for releasing the Default Bearer, the P-GW 8 transmits a message “Delete Bearer Request” to the S-GW 7. “Delete Bearer Request” is a bearer release request message associated with the Default Bearer between the P-GW 8 and the terminal 4. However, the flow information that meets conditions for transmitting the bearer release request (bearer release conditions) may be predetermined flow information other than the flow information covering all the flows to be transferred through the Default Bearer.

The other relay nodes (the S-GW 7 and the base station 5), the MME 6, and the terminal 4 in the mobile network 1 release (remove) the Default Bearer according to a normal bearer release procedure. The Dedicated Bearer is dependent on the Default Bearer. Thus, the Dedicated Bearer (including the blocking flag) associated with the Default Bearer is also released (removed) along with the removal of the Default Bearer.

Thereafter, the P-GW 8 returns Reject (rejection) to a Default Bearer resetting request from the terminal 4 for a fixed period of time (for example, a predetermined period previously set by a contract between the company network and the mobile network) or until a signal acknowledging re-communication from the IPS 3 to the terminal 4 is received. The length of the fixed period of time may be appropriately set.

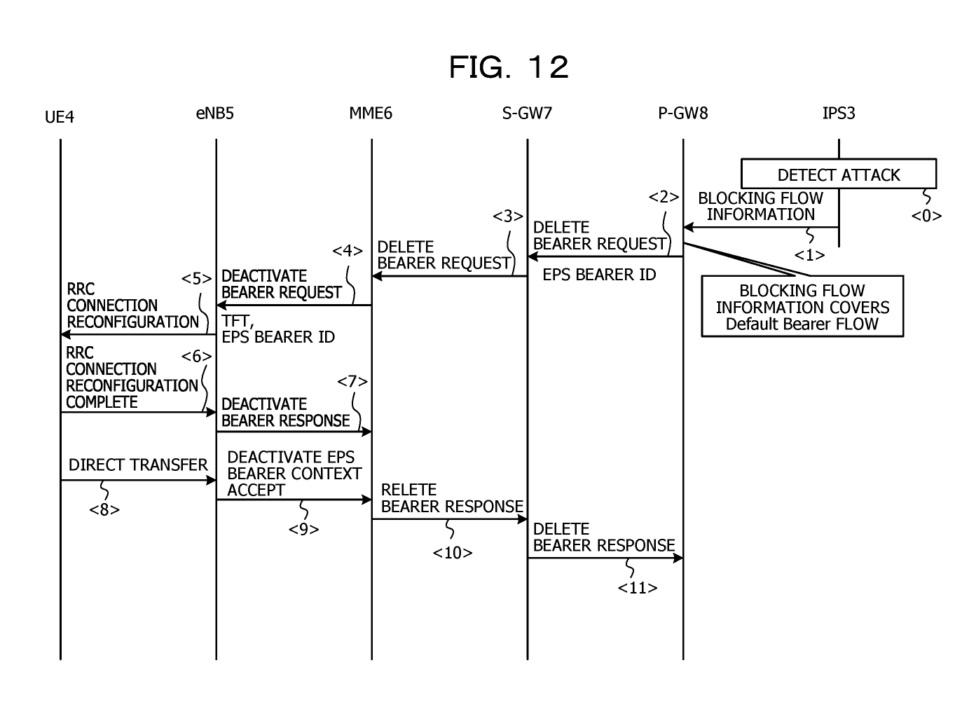

FIG. 12 is a sequence diagram illustrating an operation example of Embodiment 2. The procedure illustrated in FIG. 12 is based on PDN GW initiated bearer deactivation in 3GPP TS 23.401 §5.4.4.1. In FIG. 12, when an attack flow is detected by the IPS 3 (<0> in FIG. 12), the blocking flow information is transmitted to the P-GW 8 (<1> in FIG. 12).

The P-GW 8 determines whether or not the blocking flow information covers a Default Bearer flow. The memory 12 in the P-GW 8 previously stores information on the Default Bearer flow (Default Bearer release condition data).

When the blocking flow information coincides with the Default Bearer information, the P-GW 8 generates a message “Delete Bearer Request” to request the Default Bearer to be released (removed), and transmits the message to the S-GW 7 (<2> in FIG. 12). “Delete Bearer Request” includes the EPS Bearer ID that is the identifier of the Default Bearer.

Upon receipt of “Delete Bearer Request”, the S-GW 7 maps the information in “Delete Bearer Request” onto “Delete Bearer Request” on the MME 6 side, and transmits “Delete Bearer Request” to the MME 6 (<3> in FIG. 12).

Upon receipt of “Delete Bearer Request”, the MME 6 transmits a message “Deactivate Bearer Request” to the base station 5 and the terminal 4 for deactivating the Default Bearer (<4> in FIG. 12). “Deactivate Bearer Request” includes the information in the TFT field corresponding to the Default Bearer and the identifier (EPS Bearer ID) of the Default Bearer.

Upon receipt of “Deactivate Bearer Request”, the base station 5 transmits a message “RRC Connection Reconfiguration” to the terminal 4 to release the radio bearer between the base station 5 and the terminal 4 and the NAS link between the terminal 4 and the MME 6 (<5> in FIG. 12).

Upon receipt of “RRC Connection Reconfiguration”, the terminal 4 releases (removes) the radio bearer with the base station 5 and transmits a response message “RRC Connection Reconfiguration complete” to the base station 5 (<6> in FIG. 12). Upon receipt of “RRC Connection Reconfiguration complete”, the base station 5 transmits a response message “Deactivate Bearer Response” to “Deactivate Bearer Request” to the MME 6 (<7> in FIG. 12). “Deactivate Bearer Response” indicates that the radio bearer is released.

Moreover, the terminal 4 releases the Default Bearer in the NAS layer, generates a response message “Deactivate EPS Bearer Context Accept”, and transmits the message to the base station 5 (Direct Transfer: <8> in FIG. 12). Then, the base station 5 transmits “Deactivate EPS Bearer Context Accept” to the MME 6 (<9> in FIG. 12).

Upon receipt of “Deactivate Bearer Response” and “Deactivate EPS Bearer Context Accept”, the MME 6 transmits a response message “Delete Bearer Response” to “Delete Bearer Request” to the S-GW 7 (<10> in FIG. 12). Upon receipt of “Delete Bearer Response”, the S-GW 7 confirms that the Default Bearer is released, generates “Delete Bearer Response” to the P-GW 8, and transmits “Delete Bearer Response” to the P-GW 8 (<11> in FIG. 12). The Default Bearer is released by the procedure described above. Since the Default Bearer is released, the terminal 4 is set in a state of not being able to send a packet to the company network 2.

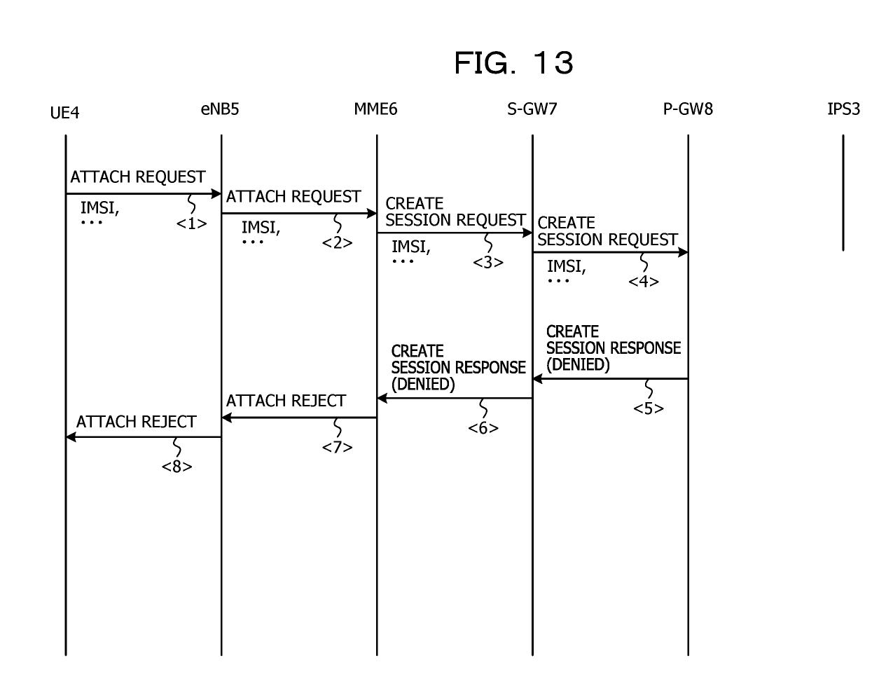

FIG. 13 illustrates a procedure example of resetting Default Bearer in the terminal 4 after the Default Bearer is released. In FIG. 13, the terminal 4 transmits a message “Attach Request” corresponding to a request to reset Default Bearer to the base station 5 (<1> in FIG. 13). “Attach Request” includes the identifier (IMSI) of the terminal 4.

The base station 5 maps information in “Attach Request” from the terminal 4 onto a signal to the MME 6, and transmits the signal to the MME 6 (<2> in FIG. 13). Upon receipt of “Attach Request”, the MME 6 transmits a Default Bearer setup request message “Create Session Request” to the S-GW 7 (<3> in FIG. 13).

The S-GW 7 maps information in “Create Session Request” onto a signal to the P-GW 8, and transmits the signal to the P-GW 8 (<4> in FIG. 13). The memory 12 in the P-GW 8 stores determination information to be used to determine whether or not conditions for enabling resetting of the Default Bearer from the terminal 4 to be accepted (resetting enabled conditions) are met (resettability determination). The determination information is information indicating whether or not a certain period of time has passed since the release of the Default Bearer, for example. Alternatively, the determination information is information indicating whether or not information allowing a packet from the terminal 4 to be received from another device (IPS 3). When the determination information does not meet the resetting enabled conditions, the P-GW 8 generates a response message “Create Session Response (denied)” that denies “Create Session Request”, and transmits the message to the S-GW 7 (<5> in FIG. 13).

The S-GW 7 maps “Create Session Response (denied)” onto a signal to the MME 6, and transmits the signal to the MME 6 (<6> in FIG. 13). Upon receipt of “Create Session Response (denied)” from the S-GW 7, the MME 6 transmits a message “Attach Reject” that rejects the resetting of the Default Bearer to the base station 5 (<7> in FIG. 13). Then, the base station 5 transmits a signal indicating “Attach Reject” to the terminal 4 through a radio link (<8> in FIG. 13).

As described above, once the Default Bearer is released, the resetting of the Default Bearer is rejected until the resetting enabled conditions are met. Thus, the packet of the attack flow is avoided from being transmitted to the company network 2.

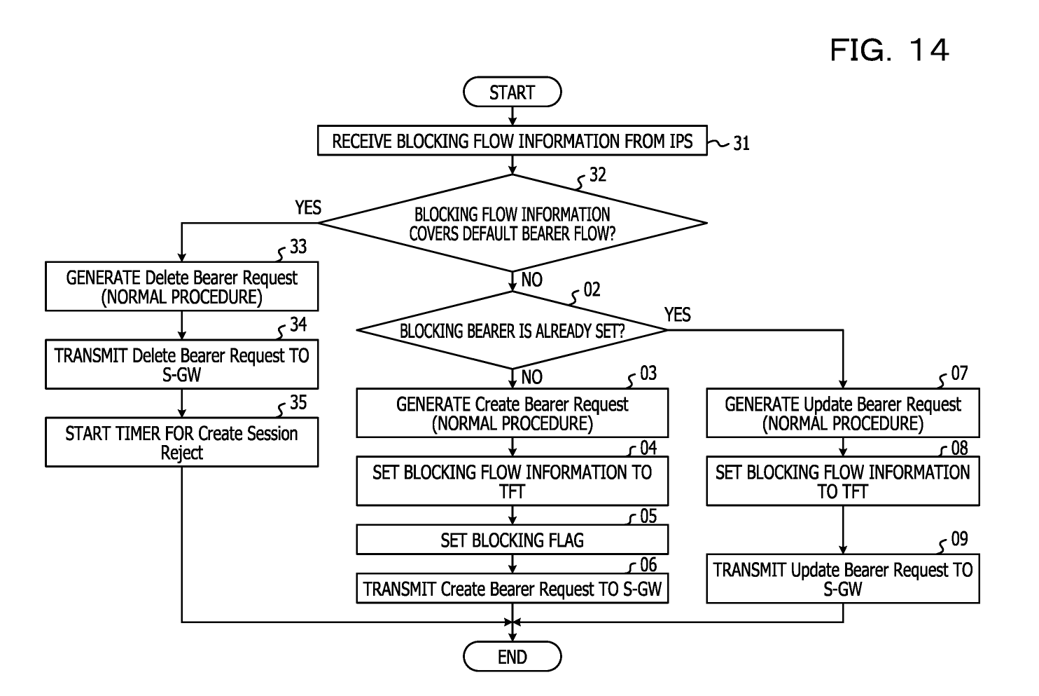

FIG. 14 is a flowchart illustrating a processing example of the P-GW 8 according to Embodiment 2. The processing illustrated in FIG. 14 is executed by the CPU 11 in the information processor 10 operating as the P-GW 8.

In “31”, the CPU 11 receives blocking flow information from the IPS 3. In “32”, the CPU 11 determines whether or not the blocking flow information covers a flow to be transferred through the Default Bearer. The information indicating the flow to be transferred through the Default Bearer is previously stored in the memory 12.

When the blocking flow information covers the flow to be transferred through the Default Bearer (“32”; Y), the processing advances to “33”. On the other hand, when the blocking flow information does not cover the flow to be transferred through the Default Bearer (“32”; N), the processing advances to “02”.

The CPU 11 generates a message “Delete Bearer Request” in “33”, and then transmits “Delete Bearer Request” to the S-GW 7 in “34”. In “35”, the CPU 11 starts a timer for Create Session Reject. The timer is a timer for timing a period for rejecting a Delete Bearer resetting request. Upon completion of the processing of “35”, the CPU 11 terminates the processing in FIG. 14. The processing of 02 to 09 in FIG. 14 is the same as the processing of “02” to “09” described in Embodiment 1 (FIG. 7), and thus description thereof is omitted.

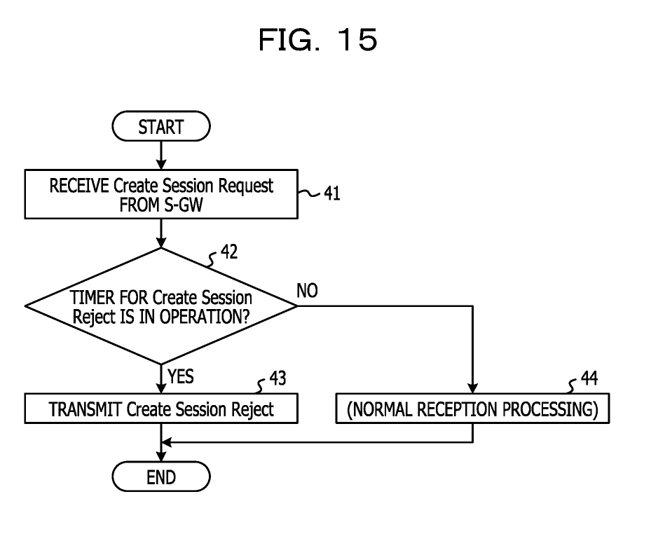

FIG. 15 is a flowchart illustrating a processing example of the P-GW 8 after completion of the processing of 35 in FIG. 14. In “41”, the CPU 11 receives “Create Session Request” from the S-GW 7. In “42”, the CPU 11 determines whether or not the timer started by the processing of “35” is in operation (before expiration). When the timer is before the expiration (“42”; Y), the CPU 11 transmits a message “Create Session Reject” to the S-GW 7. Thus, the resetting is rejected. On the other hand, when the timer has expired (“42”; N), the CPU 11 performs normal reception processing. Thus, the Default Bearer is reset in the mobile network 1. According to the processing of FIGS. 14 and 15, the resetting of the Default Bearer is prohibited until the conditions set by the contract between the company network and the mobile network, for example, are met (until the timer expires) after the Default Bearer is determined to be released. The expiration of the timer is an example of the predetermined conditions.

Note that, in Embodiment 2, the description is given of the example where the P-GW 8 rejects the Default Bearer resetting request. However, a configuration may be adopted, in which any of the S-GW 7, the MME 6, and the base station 5 rejects the resetting request.

For example, upon receipt of “Delete Bearer Request” (<3> in FIG. 12: including the IMSI of the terminal 4), the MME 6 transmits a request to reject the location registration of the terminal 4 (including the IMSI) to the HSS. In response to the reject request, the HSS is set in a state of rejecting the location registration from the MME 6 for a predetermined period of time set by the contact between the company network and the mobile network. In response to the rejection of the location registration from the HSS, the MME 6 transmits a message indicating the rejection of the location registration, which is a response to “Attach Request” (<2> in FIG. 13) from the terminal 4, to the terminal 4 for the predetermined period of time.

The predetermined period may be counted by a timer on a computer operating as the HSS. When the timer expires, the HSS returns to a state of accepting the location registration. Alternatively, the predetermined period may be counted by a timer on a computer (information processor 10) operating as the MME 6. When the timer on the MME 6 expires, a request to release the rejection of the location registration may be transmitted to the HSS, and the HSS may shift to the state of accepting the location registration in response to the release request.

When the HSS is set in the state of rejecting the location registration, a bearer resetting request for the terminal 4 from an MME different from the MME 6 is also rejected. Thus, the terminal 4 is prohibited from accessing the company network 2 for a predetermined period of time regardless of the location thereof. Alternatively, the MME 6 may reject the location registration request (Attach Request) from the terminal 4 until the timer expires.

Moreover, in Embodiment 2, the description is given of the example where the Default Bearer between the P-GW 8 and the terminal 4 is released. Instead of the configuration described above, the following configuration may be adopted. When the blocking flow information indicates a specific flow, the P-GW 8 transmits the identifier (for example, the IMSI) of the terminal 4 to the S-GW 7 along with a message requesting to cut off the connection with the terminal 4. The S-GW 7 transits the cutoff request including the IMSI to the MME 6. Upon receipt of the cutoff request, the MME 6 transmits an instruction to cut off the radio connection (RRC connection) with the terminal 4 to the base station 5. In response to the cutoff instruction, the base station 5 cuts off the RRC connection with the terminal 4. The RRC connection is an example of the “radio connection between the mobile terminal and the mobile network”. Note that the identifier of the terminal 4 may be transmitted along with a message other than the message requesting to cut off the connection with the terminal 4.

After cutting off the RRC connection, the base station 5 starts counting with a predetermined timer, and rejects an RRC connection request (random access procedure) from the terminal 4 until the timer expires. The configurations of the embodiments described above may be combined as appropriate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system configured to control a packet communication between a terminal device and an information processing device, the communication system comprising:
a memory; and
at least one processor coupled to the memory and configured to:
set a first communication path between the communication system and the terminal device,
receive a first packet from the terminal device through the first communication path, a destination of the first packet being the information processing device,
detect that the first packet belongs to a first flow and is to be blocked before the first packet reaches the information processing device,
set a second communication path for the first flow between the terminal device and the communication system,
receive a second packet belonging to the first flow from the terminal device through the second communication path, and
block the second packet not to be sent to the information processing device.

2. The communication system according to claim 1, wherein the at least one processor is configured to block the second packet not to be sent to the information processing device without checking whether the second packet belongs to the first flow.

3. The communication system according to claim 1, wherein
the first communication path is a first bearer, and
the second communication path is a second bearer.

4. The communication system according to claim 1, wherein
the first flow is an attack communication flow,
the second communication path is blocking path for the attack communication flow, and
the communication system generate flow information indicating the attack communication flow.

5. The communication system according to claim 1, wherein the second packet is transferred to a device different from the information processing device.

6. The communication system according to claim 1, wherein a transmission rate of a plurality of packets transferred through the second communication path is set lower than a transmission rate of a plurality of packets transferred through the first communication path.

7. The communication system according to claim 4, wherein the communication system is located between the terminal device and the information processing device, and the communication system includes at least one of a gateway, a base station, a relay device configured to relay packets from the terminal device, and a controller of the relay device.

8. The communication system according to claim 7, wherein
when the flow information indicates that all flows transferred through the first communication path corresponds to the attack communication flow, the at least one processor is configured to:
cut off the first communication path, and
prohibit to reset the first communication path until a certain condition is met for any of the gateway, the relay device, and the controller of the relay device.

9. A communication method using a communication system configured to control a packet communication between a terminal device and an information processing device, the method comprising:
setting, by the communication system, a first communication path between the communication system and the terminal device;
receiving, by the communication system, a first packet from the terminal device through the first communication path, a destination of the first packet being the information processing device;
detecting, by the communication system, that the first packet belongs to a first flow and is to be blocked before the first packet reaches the information processing device;
setting, by the communication system, a second communication path for the first flow between the terminal device and the communication system;
receiving, by the communication system, a second packet belonging to the first flow from the terminal device through the second communication path; and
blocking, by the communication system, the second packet not to be sent to the information processing device.

10. The communication method according to claim 9, wherein in blocking the second packet not to be sent to the information processing device, the communication system blocks the second packet without checking whether the second packet belongs to the first flow.

11. The communication method according to claim 9, wherein
the first communication path is a first bearer, and
the second communication path is a second bearer.

12. The communication method according to claim 9 further comprising:
generating, by the communication system, flow information indicating an attack communication flow, wherein
the first flow is the attack communication flow, and
the second communication path is blocking path for the attack communication flow.

13. The communication method according to claim 9, further comprising:
transferring, by the communication system, the second packet to a device different from the information processing device.

14. The communication method according to claim 9, wherein a transmission rate of a plurality of packets transferred through the second communication path is set lower than a transmission rate of a plurality of packets transferred through the first communication path.

15. The communication method according to claim 12, wherein the communication system is located between the terminal device and the information processing device, and the communication system includes at least one of a gateway, a base station, a relay device configured to relay packets from the terminal device, and a controller of the relay device.

16. The communication system according to claim 15, when the flow information indicates that all flows transferred through the first communication path corresponds to the attack communication flow, the method further comprising:
cutting off, by the communication system, the first communication path; and
prohibiting, by the communication system, to reset the first communication path until a certain condition is met for any of the gateway, the relay device, and the controller of the relay device.

17. A gateway configured to control a packet communication between a terminal device and an information processing device, the gateway comprising:
a memory; and
at least one processor coupled to the memory and configured to:
receive a first packet from the terminal device through a first communication path, a destination of the first packet being the information processing device,
detect that the first packet belongs to a first flow and is to be blocked before the first packet reaches the information processing device, and
generate a request requesting to set a second communication path for the first flow between the terminal device and the communication system.
